(19) United States
(12) Patent Application Publication
(10) Pub. No.: US 2015/0033613 A1
(43) Pub. Date: Feb. 5, 2015

(54) Customizable Jointed Fishing Lure

(71) Applicant: Louis Colucci, Hewitt, NJ (US)

(72) Inventor: Louis Colucci, Hewitt, NJ (US)

(21) Appl. No.: 14/518,493

(22) Filed: Oct. 20, 2014

Related U.S. Application Data
(63) Continuation-in-part of application No. 13/374,363, filed on Dec. 24, 2011.

(51) Int. Cl. A01K 85/00

(52) U.S. Cl. CPC A01K 85/00
USPC 43/42.09

(57) ABSTRACT

A customizable fishing lure includes multiple lure sections which are releasably interconnected by a series of non-swiveling joints, about which the lure sections are free to revolve, but do not axially rotate. The joints maintain a series of gaps between adjoining lure sections, so that the pivoting movement of each lure section produces an overall life-like undulating motion of the lure. Each lure section can be readily detached at the pivoting joints, thereby disconnecting it from the lure and enabling its replacement by a substitute lure section.

### REFERENCE TO RELATED APPLICATION

The present application is a continuation-in-part of application Ser. No. 13/374,363, filed Dec. 24, 2011.

### FIELD OF INVENTION

The present invention relates to the field of equipment and devices used in sports fishing, and more particularly to fishing lures.

### BACKGROUND OF THE INVENTION

One of the most artful and creative aspects of sports fishing is the design of lures. A wide variety of lures are used to attract various species of fish, and lure features must also be adapted to weather and water conditions. These changeable demands present a challenge to the angler, who can only carry a limited number of lures and cannot afford to waste a lot of fishing time in changing lures.

The present invention addresses this problem by providing a modular lure system with interchangeable head, body and tail segments. By mixing and matching a handful of interchangeable lure components, the angler can create a large number of distinctive composite lures. Moreover, the innovative quick clasp system of the present invention enables the angler to interchange lure components rapidly and without re-rigging the hook and leader.

### SUMMARY OF THE INVENTION

The customizable fishing lure of the present invention comprises multiple lure sections which are releasably interconnected by a series of non-swiveling joints, about which the lure sections are free to revolve, but do not axially rotate. The joints maintain a series of gaps between adjoining lure sections, so that the pivoting movement of each lure section produces an overall life-like undulating motion of the lure. Each lure section can be readily detached at the pivoting joints, thereby disconnecting it from the lure and enabling its replacement by a substitute lure section.

Replacement of one or more lure sections in this manner allows the angler to quickly change the appearance of the lure to resemble a different type of bait to attract a different fish. The appearance of the lure can also be modified in this way to adjust to changing light, weather, depth, and/or water conditions.

The rapid detachment and replacement of lure sections is attributable to the quick release structure of the joints, consisting of two wire loops, one of which accepts the insertion of the other to accomplish the interconnection. This type of joint allows the adjoining sections to revolve and pivot with respect to one another, so as to undergo a life like undulating motion attractive to fish, but not to rotate axially, which would engender an unnatural motion likely to repel fish.

Due to the structure of the lure, fishing line cannot pass through the lure, but would be attached by connectors at one or both ends of the lure. Hooks would also be attached by connectors to any one or more of the lure sections, enabling a variety of riggings.

The foregoing summarizes the general design features of the present invention. In the following sections, specific embodiments of the present invention will be described in some detail. These specific embodiments are intended to demonstrate the feasibility of implementing the present invention in accordance with the general design features discussed above. Therefore, the detailed descriptions of these embodiments are offered for illustrative and exemplary purposes only, and they are not intended to limit the scope either of the foregoing summary description or of the claims which follow.

### BRIEF DESCRIPTION OF THE DRAWINGS

FIG. 1A is a side profile view of a customizable fishing lure according to the tri-sectional embodiment of the present invention;

FIG. 1B is a top plan of the fishing lure shown in FIG. 1A;

FIG. 1C is a detail view of the quick release joint of the fishing lure depicted in FIGS. 1A and 1B;

FIG. 2A is a side profile view of customizable fishing lure according to the bi-sectional embodiment of the present invention;

FIG. 2B is a side profile view of the tri-sectional embodiment with substitute lure sections;

FIG. 2C is a side profile view of the tri-section embodiment with substitute lure sections; and

FIG. 3 is a perspective view of a customizable jointed fishing lure with hooks attached to the tail section.

### DETAILED DESCRIPTION OF THE PREFERRED EMBODIMENT

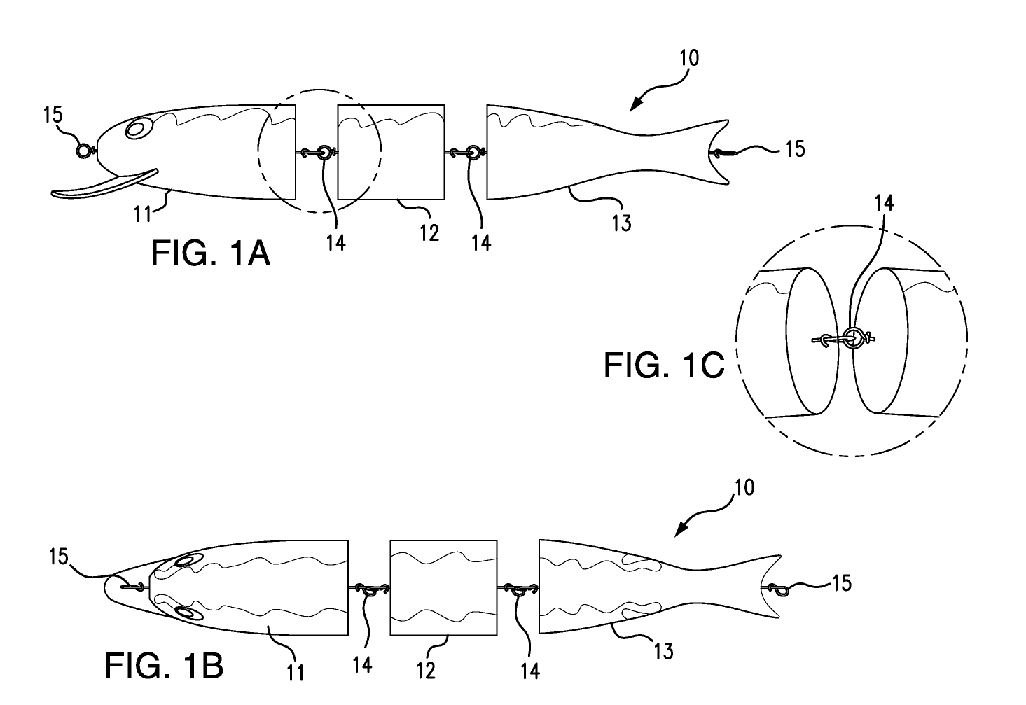

Referring to FIGS. 1A and 1B, the exemplary customizable jointing fishing lure 10 comprises a head section 11, a body section 12 and a tail section 13. Pivoting joints 14 interconnect the lure sections, and a detail view of one joint 14 is depicted in FIG. 1C. Connectors 15 at either end of the lure 10 are configured to accept rigging, such as leaders and/or hooks.

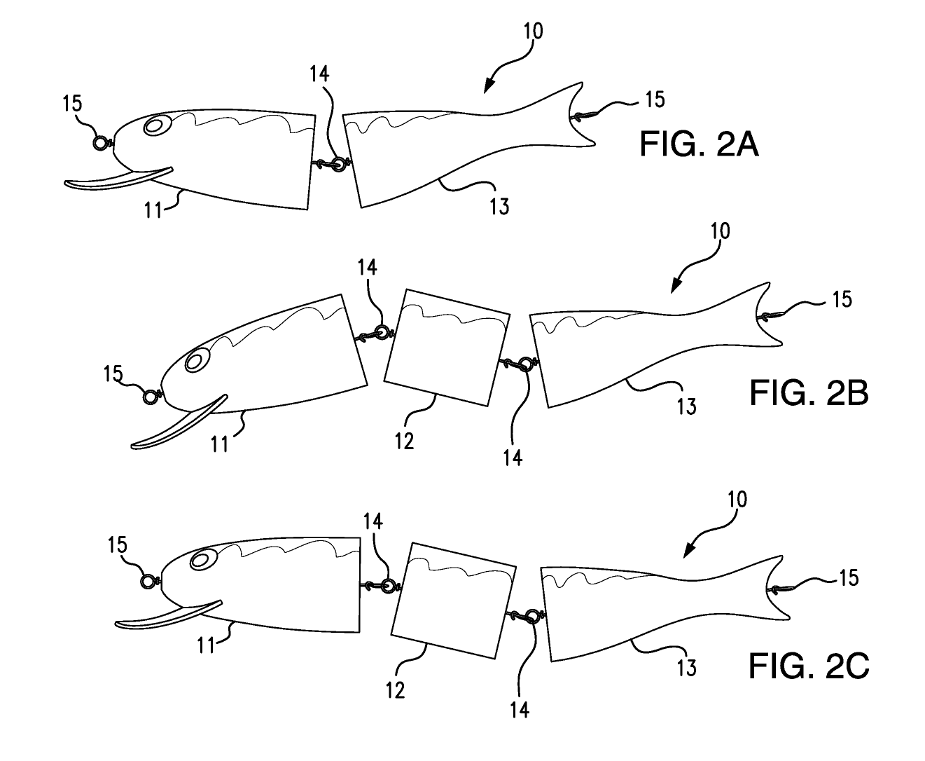

An alternate view of the lure is depicted in FIG. 2A, comprising only a head section 11 and a tail section 13, with an interconnecting pivoting joint 14 and rigging connectors 15.

As shown in FIGS. 2B and 2C, replacement lure sections 11, 12, 13 can be inserted to alter the appearance of the lure 10 so as to resemble a different bait attractive to a different fish species.

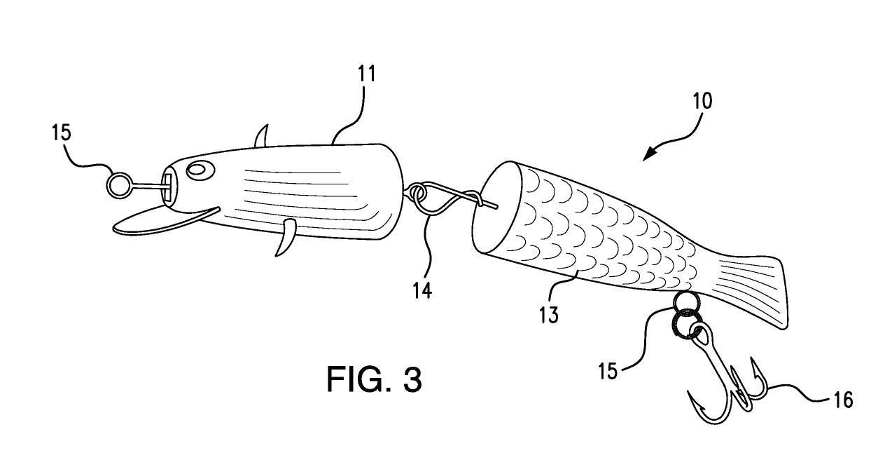

FIG. 3 shows the bi-sectional version of the composite lure 10 rigged with hooks on the tail section 13.

Although the preferred embodiment of the present invention has been disclosed for illustrative purposes, those skilled in the art will appreciate that many additions, modifications and substitutions are possible, without departing from the scope and spirit of the present invention as defined by the accompanying claims.

What is claimed is:

1. A customizable fishing lure, comprising:
multiple interchangeable lure sections releasably interconnected by a series of non-swiveling, pivoting joints in uniformly spaced sequential relation to one another;
one or more connectors located on one or more of the lure sections, with each connector configured to attach to one or more fishing hooks or leaders;
wherein the pivoting joints maintain a series of uniform sectional gaps separating adjoining lure sections;
wherein the pivoting joints and the sectional gaps are cooperatively configured to enable each lure section to revolve about of one more of the pivoting joints, but not to axially rotate about any pivoting joint, such that the lure sections are collectively configured to undergo an undulating motion; and
wherein each lure section can be detached at the pivoting joints and disconnected from the lure and replaced with one or more substitute lure sections.

2. The fishing lure of claim 1, wherein each of the pivoting joints comprises two mutually cooperatively engageable looped wires, and wherein each looped wire is attached to one of two adjoining lure sections.

3. The fishing lure of claim 2, wherein the fishing lure comprises three lure sections, consisting of a front section, a middle section and an end section.

4. The fishing lure of claim 3, wherein the front section, the middle section and the end section have a structure, markings and coloring resembling, respectively, a head, a body and a tail of a bait or a specific bait species.

5. The fishing lure of claim 4, wherein the bait or bait species is modifiable by replacing one or more of the front section, the middle section and the end section with one or more corresponding substitute lure sections.
